(19) United States
(12) Patent Application Publication
(10) Pub. No.: US 2006/0212507 A1
(43) Pub. Date: Sep. 21, 2006

(54) Location-based historical performance information for entertainment devices

(76) Inventors: Darren L. Clark, Concord, CA (US); Howard L. Spielman, San Francisco, CA (US); Robbie O. Vann-Adibe, San Francisco, CA (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/083,592

(22) Filed: Mar. 18, 2005

(51) Int. Cl. G06F 15/16

(52) U.S. Cl. 709/200

(57) ABSTRACT

Methods and systems for operating an entertainment network are provided. The method includes: receiving a request to perform entertainment content at a venue; performing the entertainment content at the venue with an entertainment device; and transmitting to a user device at the venue information regarding the performed entertainment content. The entertainment network includes: an entertainment device for performing entertainment content in a venue in response to user requests; a wireless link for providing network connectivity to one or more user devices in the venue; and a host system including a web server, said host system being coupled to the entertainment device and the wireless link for providing information regarding entertainment content performed by the entertainment device to the one or more user devices in the venue via the wireless link.

### BACKGROUND OF THE INVENTION

Traditional entertainment devices for out-of-home use, for example in restaurants or bars, are typified by the jukebox that plays selected vinyl records or compact discs after the insertion of coins or paper currency.

More recently, entertainment devices for public venues have begun to provide additional forms of entertainment beyond merely playing music from compact discs. Some entertainment devices are provided with personal computer architecture and are equipped with hard drives capable of storing huge libraries of music, video, and games. Patrons of the venue may operate the entertainment device to provide the desired service, such as to play a selected song or display a selected music video.

These entertainment devices may include displays for providing information regarding entertainment content currently being performed. For example, in CD-based jukeboxes, a CD identification number and track number for the currently playing song may be displayed on a digital LED display. More contemporary jukeboxes have been provided with video monitors that are capable of displaying complex text and graphics, so detailed information regarding the current song, artist, and album may be displayed during performance. However, these systems typically require that a person be in fairly close proximity to the entertainment device in order to read the entertainment content information from the display. Others who are located elsewhere in the venue may be able to hear the song being played and may be curious about the artist or song title. However, these individuals will not be able to view the title and artist information from the display on the entertainment device unless they physically approach the device. Customers may find this to be sufficiently inconvenient that they will not bother making the effort.

In addition to merely performing for consumers the requested entertainment content, it may be desirable to provide consumers with additional information and services, which could, in turn, increase revenue and brand loyalty. Accordingly, it may be desirable to provide consumers and others present at the venue with additional information and services related to the entertainment services being performed. This information can then be used to generate increased interest in the various services provided by the entertainment.

### SUMMARY OF THE INVENTION

Systems and methods are provided for allowing users to easily access a history of recent content performances from an entertainment device using devices other than the device that performed the content. The ability to offer to consumers, on their personal wireless devices, real-time information that is specific to entertainment content performed at their current location can enable a variety of new services to be provided, which range from, e.g., simply informing patrons and consumers of the artists and titles of recent performances of songs and videos, to allowing them to rate their preferences for recently performed content, to offering them the ability to buy that content, or other similar content based on their preferences.

In accordance with embodiments of the present invention, each entertainment device is connected to a network. As each piece of content is performed, the entertainment device sends a record of that performance to a host system that will record it within a central database, identifying the location, the date and time, and the content performed. This central record of performances may be used in turn by other services offered by the provider of entertainment content on other devices in the location, including personal devices owned by consumers and patrons. Wireless access can be offered to consumers in the location via their personal cell phones, laptop computers, or other electronic devices. Using a browser application, each user's device could display a list of the most recent content performances in the location. This would greatly enhance the consumer experience by informing consumers of the artists and titles of interesting new entertainment content with which they were not previously acquainted, and giving them the opportunity to rate, purchase, or learn more about that content or the artist who performed it.

In accordance with embodiments of the present invention, a method of operating an entertainment network is provided, comprising: receiving a request to perform entertainment content at a venue; performing the entertainment content at the venue with an entertainment device; and transmitting to a user device at the venue information regarding the performed entertainment content.

In accordance with other embodiments of the present invention, an entertainment network is provided, comprising: an entertainment device for performing entertainment content in a venue in response to user requests; a wireless link for providing network connectivity to one or more user devices in the venue; and a host system comprising a web server, said host system being coupled to the entertainment device and the wireless link for providing information regarding entertainment content performed by the entertainment device to the one or more user devices in the venue via the wireless link.

In accordance with other embodiments of the present invention, an method of operating an entertainment network is provided, comprising: receiving login information from a user device; identifying a venue where the user device is located; and providing information to the user device regarding entertainment content performed by an entertainment device at the venue.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### DESCRIPTION OF THE DRAWINGS

FIG. 1 shows a simplified block diagram of a venue having an entertainment device and a wireless local area network, in accordance with embodiments of the present invention.

FIG. 2 is a flow diagram depicting a method of providing historical entertainment content performance information to users in a venue, in accordance with embodiments of the present invention.

FIG. 3 shows a simplified block diagram of a system for providing historical entertainment content performance information to users, in accordance with embodiments of the present invention.

FIG. 4 is a flow diagram depicting a method of providing historical entertainment content performance information to users in a venue, in accordance with embodiments of the present invention.

FIG. 5 is a simplified block diagram of an exemplary jukebox-type entertainment device, in accordance with embodiments of the present invention.

FIG. 6 shows an exemplary login screen viewed by a browser application running on a user device, in accordance with embodiments of the present invention.

### DETAILED DESCRIPTION

In the following description, reference is made to the accompanying drawings which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense, and the scope of the embodiments of the present invention is defined only by the claims of the issued patent.

Some portions of the detailed description which follows are presented in terms of procedures, steps, logic blocks, processing, and other symbolic representations of operations on data bits that can be performed on computer memory. Each step may be performed by hardware, software, firmware, or combinations thereof.

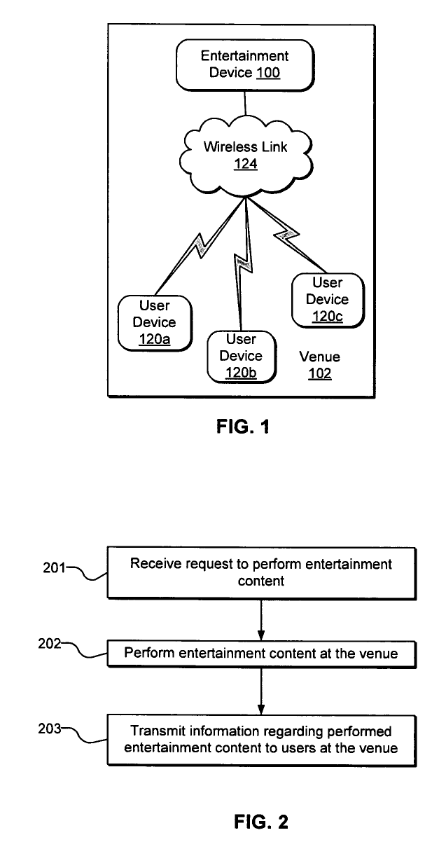

FIG. 1 shows a simplified block diagram of a venue 102 including an entertainment device 100, a wireless link 124, and a plurality of user devices 120a-120c coupled to the wireless link 124. The entertainment device 100 may comprise a jukebox capable of performing a variety of songs and/or videos in response to user requests, as will be described in greater detail below. The wireless link 124 may comprise any type of wireless connection, such as a wireless local area network (WLAN) providing wireless connectivity, e.g., a wireless access point complying with the IEEE 802.1X specification. In other embodiments, other types of wireless communication protocols may be used. The user devices 120 may comprise, e.g., laptops, handhelds, personal digital assistants (PDAs), cellular telephones, or other electronic devices capable of coupling to the wireless link 124.

FIG. 2 is a flow diagram depicting a method of providing historical entertainment content performance information to users in a venue, in accordance with embodiments of the present invention. In step 201, the entertainment device 100 receives a request to perform entertainment content. In step 202, the entertainment device 100 performs the requested entertainment content at the venue. This requested entertainment content can be provided in a variety of ways, such as by audio broadcast and/or visual display. In step 203, information regarding the performed entertainment content is transmitted to users at the venue.

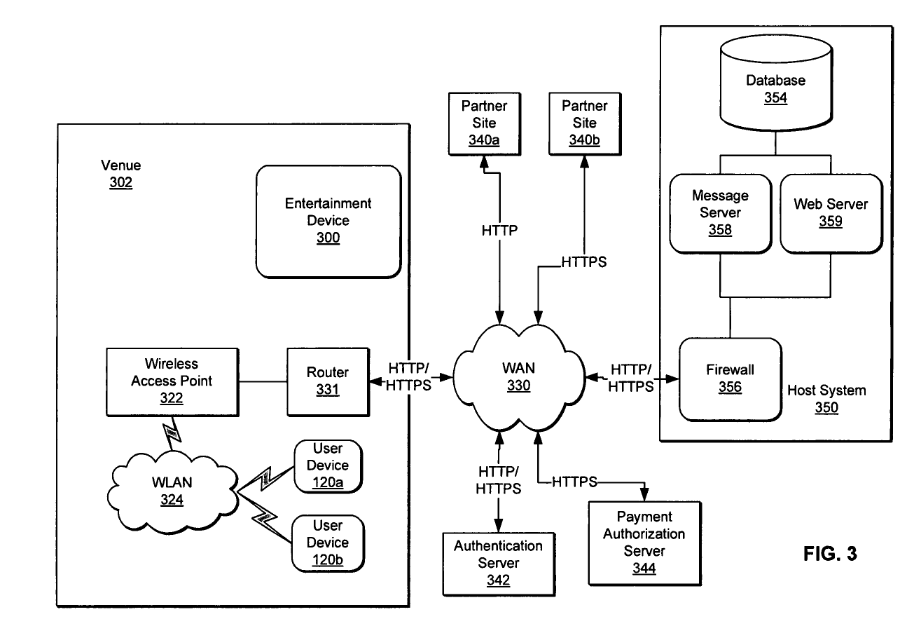

FIG. 3 shows a more detailed block diagram of a system for providing historical entertainment content performance information to users, in accordance with embodiments of the present invention. An entertainment device 300 is provided in a venue 302. The venue 302 can be, e.g., a bar, a restaurant, an arcade, or other public or private location where a plurality of users are present. A plurality of user devices 120a-120b are located in the venue 302. Although two user devices 120a-120b are shown, it will be understood that greater or fewer devices 120 may be present. The entertainment device 300 is coupled to a host system 350 via a wide area network (WAN) 330. The various components shown in FIG. 3 may communicate with each other using various communication protocols, such as HTTP or HTTPS, as would be understood by those of ordinary skill in the art.

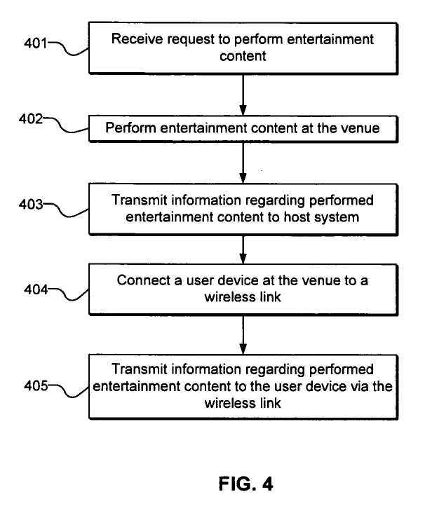

FIG. 4 is a flow diagram depicting a method of providing historical entertainment content performance information to users in the venue 302, in accordance with embodiments of the present invention. In step 401, the entertainment device 300 receives a request to perform entertainment content. In step 402, the entertainment device 300 performs the requested entertainment content at the venue 302. In step 403, information regarding the performed entertainment content is transmitted to the host system 350. In step 404, a user device 120 is connected to a wireless link (e.g., a wireless local area network (WLAN) 324) in the venue 302. Finally, information regarding the performed entertainment content is transmitted to the user device 120 via the wireless link.

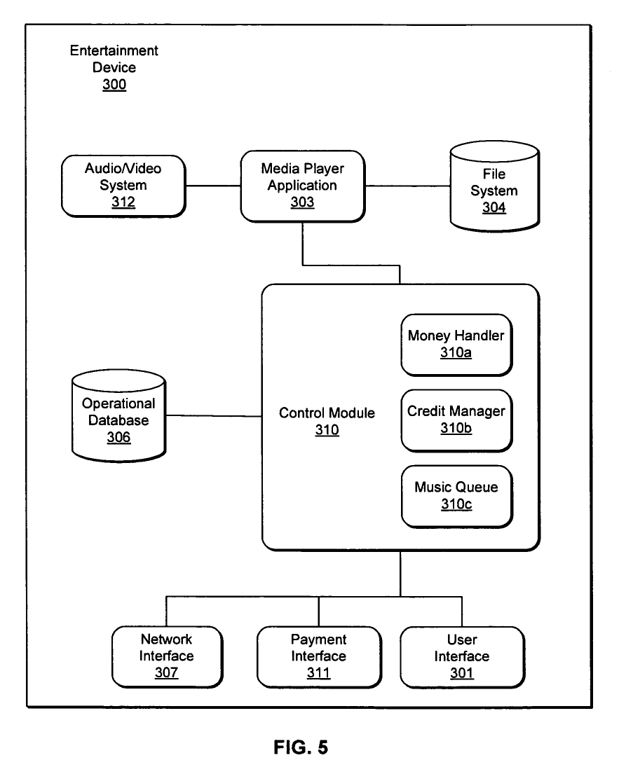

The entertainment device 300 may comprise any of a variety of network-enabled entertainment devices, such as, e.g., freestanding jukeboxes, wall mounted jukeboxes, countertop units, and dedicated gaming units. These entertainment devices 300 may provide users with entertainment content in various forms, such as, e.g., audio, video, graphics, video games, software, text, and combinations thereof. An exemplary entertainment device 300 is shown in FIG. 5.

FIG. 5 is a simplified block diagram of an exemplary jukebox-type entertainment device 300. The entertainment device 300 may take various forms, but in the illustrated embodiment comprises a jukebox having a user interface 301, which may comprise a user input device enabling a user at the venue 302 to input commands into the entertainment device 300. The user interface 301 may comprise, e.g., a keyboard, a touchpad, a mouse, a touch screen, or other input device, as would be understood by those of ordinary skill in the art.

The entertainment device 300 also comprises an audio/video system 312, which enables the entertainment device 300 to perform entertainment content, either in response to user requests or on a periodic basis (such as every ten minutes if there are no user requests pending). The audio/video system 312 may comprise an amplifier and audio speakers for playing music and a monitor for displaying video images. In other embodiments, the audio/video system 312 may couple to an amplifier and/or speakers located elsewhere in the venue 302 external to the entertainment device 300. A media player application 303 (such as, e.g. the Windows Media Player by the Microsoft Corporation of Seattle, Washington) is provided for causing the audio/video system 312 to perform the requested entertainment content. For example, when the requested entertainment content comprises a song, the media player application 303 will retrieve from the file system 304 the digital file containing audio data (e.g., encoded using WMA or MP3 compression algorithms) corresponding to the requested song. The media player application 303 will process the digital file to produce an analog audio signal that can be played over loudspeakers located either within the entertainment device 300 or elsewhere in the venue 302.

A payment interface 311 may be provided for receiving payment from customers in exchange for providing the entertainment services. In some embodiments, the payment interface 311 may comprise a coin and/or bill collector for receiving cash or token payment, a debit/credit card reader for reading the magnetic strip on customer debit or credit cards and for requesting payment authorization from the financial services provider associated with that debit or credit card, a smart card reader, any combination of the above, or any other payment receiving mechanism. A network interface 307 provides an interface between the entertainment device 300 and the WAN 330 and may comprise, e.g., an RJ-11 port, a wireless adapter, or a modem. An operational database 306 for storing various configuration setting values and information about the entertainment content is also provided. Finally, a control module 310 is provided for managing the various functions of the entertainment device 300. The control module 310 may comprise multiple modules for managing the various features of the entertainment device 300. These modules may include, for example, a money handler 310a for managing monetary payment from customers, a credit manager 310b for managing the consumption of credits, and music queue 310c for managing the performance of entertainment content selected by users. The entertainment device 300 may be implemented using, for example, standard personal computer hardware and architecture.

A router 331 may be provided for coupling the wireless access point 322 and the network interface 307 of the entertainment device 300 to the WAN 330. The WAN 330 may comprise, for example, the Internet, and the various systems described herein may connect to the WAN 330 via various mechanisms, as would be understood by those of ordinary skill in the art. For example, the systems may have a broadband connection to the Internet, and may be continuously or intermittently coupled to the WAN 330. In this embodiment, the wireless access point 322 comprises a wireless LAN transceiver that serves as a central hub of wireless communications and provides a bridging function between the wireless network of WLAN 324 and the wired network WAN 330 via the router 331. In other embodiments, the wireless access point 322 and the router 331 may be provided in a single device. One exemplary device is the OfficeConnect ADSL Wireless 11g Firewall Router sold by 3COM Corporation of Marlborough, Massachusetts, which provides in a single housing an ADSL modem, a 802.11g access point, a router, a firewall, a four-port switch, and a RJ-11 port to provide WAN connectivity.

The host system 350 may comprise a central management system for controlling the entertainment device 300 and other similar entertainment devices coupled to the WAN 330. This host system 350 may take various forms, and may comprise multiple components executed on a single server or across multiple servers located in the same facility or geographically dispersed. The illustrated host system 350 is only exemplary and omits certain components for clarity. In other embodiments, the host system 350 may include greater or fewer components.

As shown, the host system 350 comprises a message server 358 that can transmit and receive messages to and from a plurality of entertainment devices 300 coupled to the WAN 330. The host system 350 may further comprise a web server 359, which generates the web pages displayed on user devices 120. A database 354 is provided for storing the information regarding the entertainment content available to the entertainment devices 300. The database 354 may store metadata associated with the entertainment content, such as, e.g., title, artist, and album information corresponding to each musical song file. Finally, the host system 356 may further comprise a firewall 356, which provides secure connectivity to the WAN 330.

The embodiment shown in FIG. 3 can operate as follows. The entertainment device 300 includes a local file system 304 storing a plurality of different entertainment content files available to customers. These customers can utilize the user interface 301 and payment interface 311 to select and pay for the performance of entertainment content. When the customer attempts to pay for the performance using, e.g., a credit card or ATM card, the entertainment device 300 can connect to a payment authorization server 344 in order to authorize the payment. The control module 310 maintains a queue of requested entertainment content and will instruct the media player application 303 to play each requested entertainment content in turn from the queue or according to some other prioritization scheme.

The control module 310 will transmit a message to the message server 358 of the host system 350 via WAN 330 containing information regarding the performed entertainment content. This message may comprise, e.g., an XML message, and may include information such as, e.g., a Location ID uniquely identifying the venue where the content was performed, a Device ID uniquely identifying the device or disk drive that was used, the local time of the performance at the location, a Content ID uniquely identifying the performed entertainment content, an indication of whether the entertainment content was performed by request or by automatic playback, and the price paid for the performance. These messages may be sent each time an entertainment content item is requested or performed, or may be sent periodically including information regarding a plurality of performed entertainment content items. The host system 350 receives the message from the entertainment device 300 and stores the historical performance records in the database 354. The host system 350 can then retrieve aggregate performance data regarding all of the entertainment devices 300 on the network and specific performance data on the entertainment content being requested at each device 300.

Also provided at the venue 302 is a wireless access point 322 that provides wireless access to various user devices 120a-120b. This wireless access point 322 may be coupled to the WAN 330 via the same router 331 as the entertainment device 300, or may be coupled to the WAN 330 via a separate gateway. The wireless access point 322 may be provided within the housing for the entertainment device 300 or may be a separate component that shares the same network connection. Similar wireless access points 322 are commonly provided as Wi-Fi Hotspots in cafes, hotels, and the like. The wireless access point 322 may provide wireless connectivity using any type of communication protocol, such as, e.g., IEEE 802.1X. The user devices 120a-120b may comprise, e.g., laptops, handhelds, personal digital assistants (PDAs), cellular telephones, or other electronic devices capable of connecting to the wireless access point 322 using a compatible communication protocol.

The wireless access point 322 is configured to allow new user devices 120 to connect to the WLAN 324. Upon initial connection of a user device 120 to the WLAN 324, the wireless access point 322 may be configured to direct a browser application running on the user device 120 to a predetermined web site having a login screen for the user. This login screen can be used to collect initial identity information about the user prior to allowing the user to access the WAN 330. In some embodiments where the wireless access is provided to users for a fee, the login screen can also be used to collect credit card or other payment information. In other embodiments, the wireless access may be provided to users for free. On subsequent login attempts, the user may only be required to enter a login name and password in order to connect to the WLAN 324 and access the WAN 330. The initial login screen may be provided by the web server 359 or may be provided by a separate authentication server 342. This login process is similar to the login process used at many existing WiFi Hotspot locations.

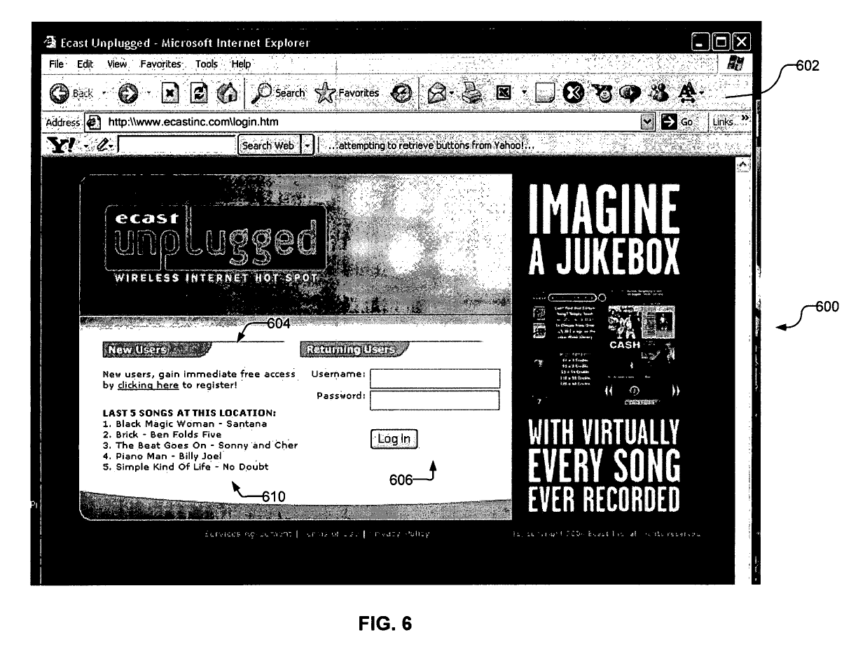

In accordance with embodiments of the present invention, user devices 120 accessing the WAN 330 via the wireless access point 322 can obtain information regarding entertainment content currently and previously performed at the venue 302. FIG. 6 shows an exemplary login screen 600 displayed on a browser application 602 on a laptop user device 120a, in accordance with one embodiment of the present invention. The login screen 600 includes a New Users portion 604 including a link to another web page requesting various types of registration information from new users, such as, e.g., name, home address, e-mail address, etc. The login screen 600 also includes a Returning Users portion 606, which allows a user who had previously registered with the host system 350 to simply enter a username and password to get access to the WAN 330. Finally, the login screen 600 also includes a performance history portion 610 which lists the last five songs that were performed by the entertainment device 300 at the location where the user device 120 is located.

The web server 359 generating the login screen 600 can identify the location of the user device 120 using a variety of methods. In some embodiments, the host system 350 will maintain a list of the Media Access Control (“MAC”) addresses, IP addresses, or device IDs of all of the wireless access points 322 deployed across the network. The host system 350 will also maintain a list of the corresponding entertainment devices 300 located in the same venue 302 as the wireless access points 322. When a user device 120a initially connects to the WLAN 324 and accesses the login screen, the host system 350 will identify the MAC address of the wireless access point 322 being accessed by the user device 120a. This MAC address can then be used to determine the identity of the entertainment device 300 at the venue 302 of the user device 120a. The host system 350 can then retrieve the historical performance information from the database 354 and include that information in the performance history portion 610 of the login screen, which is displayed on the user device 120a using, e.g., a browser application.

In the embodiment illustrated in FIG. 6, the performance history portion 610 merely shows a list of the titles and artists of the last five songs that were played. In other embodiments, additional information, links, or services may be provided. For example, additional information about the song may be provided, such as, e.g., time of performance, album title, album cover art, additional artist information, additional artist photographs, and links to the artist and/or publisher web sites. In other embodiments, links to commercial sites may be provided. These commercial sites may be provided by the host system 350 or may be third party sites accessible on the WAN 330, such as partner sites 340a-340b. For example, for each song shown, the performance history portion 610 may include a link to an online retailer where a user can purchase a compact disc of the album containing the listed song or other goods, such as posters of the artist, other albums by that artist, or other similar albums that may also be of interest to the user based on the user's interest in the listed song. In other embodiments, for each song shown, the performance history portion 610 may include a link to an online downloading service where a user can download (for a fee or for free) a digital media file of the listed song.

Various payment systems may be facilitated by embodiments of the present invention. For example, a user may enter payment into the entertainment device 300 (e.g., deposit cash or swipe a debit or credit card) and acquire credits that may be used to pay for performance of entertainment content on the entertainment device 300 at venue 302. In addition, the user may link these credits with a user account associated with the username entered into the login screen 600. With this link, the user can apply the credits as payment for various types goods and/or services from various vendors. These credits can be saved and redeemed over extended periods of time.

For example, a commercial web site which is linked to the performance history portion 610 may allow the user to apply credits normally used to pay for performances on the entertainment device 300 as payment for the various goods being offered for sale on the linked site. Thus, a user may hear a song playing on the entertainment device 300 in the venue and check the performance history portion 610 to find out the artist and title of the song. The user may then follow a link to an online retailer offering a compact disc (CD) of the album containing the song for sale over the Internet. The user can purchase the CD from the online retailer using the credits previously obtained by providing payment into the entertainment device 300. In some embodiments, the management of the credits and payments to the various vendors may be controlled by the host system 350. In other embodiments, the credits and payments can be managed by a third-party financial services company also coupled to WAN 330.

In other embodiments, the user may be able to use the browser to request that a particular song be played again or to request another song to be played. In yet other embodiments, the user may use the browser to view and search the catalog of all of the entertainment content available for request on the entertainment device 300.

In one embodiment, the historical performance information is only provided during the initial login process, as shown in FIG. 6. In accordance with other embodiments of the present invention, the web server 359 may provide a user with a mechanism for retrieving the historical performance information after the initial login process has completed. This can be accomplished in a variety of ways. For example, a frame or pop-up may be provided in the browser application running on the user device 120a. This frame or pop-up can provide historical performance information, such as the currently playing song at the venue 302 and/or the last five songs played, or the frame or pop-up can provide a link to another web site containing historical performance information. Because users generally dislike systems that usurp the conventional web browsing experience, it may be desirable to provide access to the historical performance information without disrupting the user's access to WAN 330. In one embodiment, the login screen 600 may include a button that will create in the user's browser application a bookmark link to a web page providing the historical performance information for the entertainment device 300 at the user's venue 302. The user may use this link to later return to the historical performance web page if, for example, the user hears a song of interest being played.

In another embodiment, a cookie may be stored on the user device 120a identifying the venue 302 of the user device 120a. The next time the user visits the predetermined historical performance web site, the web server 359 will examine the cookie to determine the location of the user device 120a and provide the information for that user's location. The cookie may be configured to have an expiration time so that if the user device is carried to another location and uses a different wireless access point 322 to access the WAN 330, the older cookie will be disregarded. The cookie may expire when the user closes the web browser, or may expire after a predetermined amount of time has passed, e.g., one day, one week, or one month. Allowing the cookie to persist for extended periods of time enables a user to continue to retrieve historical performance information about that venue 302 even after the user has left the venue 302.

In accordance with other embodiments of the present invention, the web server 359 may vary the type of historical performance information provided to the user depending on the type of user device 120. Most conventional browser applications in use today provide information regarding the type of device or display being used to display the browser. This information can be used to customize the type and extent of information provided. For example, in a user device having a very small screen, such as a mobile phone, PDA or handheld computer, it may be desirable to provide only limited information in text form, without excessive graphics. Thus, the information may be limited to just the title and artist of the current and one or two previously played songs. On the other hand, in a user device having a large screen, such as a laptop or personal computer, it may be desirable to provide more detailed information with graphics and other formatting. Thus, the information may include title, artist, and album cover art for the last ten songs played. Various types of logic may be implemented in the web server 359 based on the type of application and device used by the user device 120.

In accordance with other embodiments of the present invention, a user may be able to offer feedback and ratings regarding the entertainment content being performed at the venue 302. For example, the web site containing the historical performance information may also allow users to rate each entertainment content on a scale of one to ten. In addition, the web site may allow a user to enter comments or other feedback. This rating and feedback information may be collected and provided back to a manager of the entertainment device 300 at the venue 302 to assist the manager in selecting the types of entertainment content to provide on the entertainment device 300 in the future. This can help to improve customer satisfaction and increase revenue from users.

Embodiments of the present invention may provide various advantages not provided by prior art systems. Wireless users at venues can be provided new information and capabilities to learn more about artists and content, to offer feedback and ratings, and to initiate other transactions related to the entertainment content. This can improve the experience of the customers at the venue in addition to increasing revenue from direct sales and sales at partner sites 340.

While the invention has been described in terms of particular embodiments and illustrative figures, those of ordinary skill in the art will recognize that the invention is not limited to the embodiments or figures described. For example, in many of the embodiments described above, the entertainment content being performed were songs played over an audio system. In other embodiments, the entertainment content may vary and can include video, text, and graphics.

In addition, the embodiments described herein relate to either freestanding jukebox or countertop devices. In other embodiments, the entertainment devices may take other forms and may provide different types of entertainment content.

The program logic described indicates certain events occurring in a certain order. Those of ordinary skill in the art will recognize that the ordering of certain programming steps or program flow may be modified without affecting the overall operation performed by the preferred embodiment logic, and such modifications are in accordance with the various embodiments of the invention. Additionally, certain of the steps may be performed concurrently in a parallel process when possible, as well as performed sequentially as described above.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method of operating an entertainment network, comprising:
receiving a request to perform entertainment content at a venue;
performing the entertainment content at the venue with an entertainment device; and
transmitting to a user device at the venue information regarding the performed entertainment content.

2. The method of claim 1, wherein:
said transmitting to the user device comprises transmitting to the user device at the venue information regarding an entertainment content item currently being performed by the entertainment device.

3. The method of claim 1, wherein:
said transmitting to the user device comprises transmitting to the user device at the venue information regarding entertainment content items previously performed by the entertainment device.

4. The method of claim 1, wherein:
said entertainment content comprises a song or video and said transmitting to the user device at the venue information regarding the performed entertainment content comprises transmitting to the user device information regarding a title of the song or video and an artist who recorded the song or video.

5. The method of claim 1, further comprising:
providing a wireless link at the venue;
wherein said transmitting to the user device comprises transmitting information regarding the performed entertainment content via the wireless link.

6. The method of claim 5, wherein:
said providing the wireless link comprises providing a wireless local area network (WLAN) at the venue.

7. The method of claim 5, wherein:
said providing the wireless link comprises requiring a user to log into an access account to access a wide area network via the wireless link.

8. The method of claim 5, further comprising:
receiving a request to perform entertainment content from the user device via the wireless link.

9. The method of claim 1, further comprising:
receiving from the user device at the venue feedback regarding performed entertainment content.

10. The method of claim 9, wherein:
said feedback comprises a rating of the performed entertainment content.

11. The method of claim 1, wherein:
said transmitting to the user device comprises transmitting a web page to the user device at the venue, said web page including information regarding the performed entertainment content.

12. The method of claim 11, further comprising:
causing a user device to store data indicating the venue in which the user device was used to access the wireless link.

13. The method of claim 12, wherein:
said data is stored by the user device as a browser cookie.

14. The method of claim 11, further comprising:
storing a user device a link to the web page including information regarding the performed entertainment content.

15. The method of claim 11, wherein:
said providing the web page comprises providing a link to a commercial web site offering sales of products related to the performed entertainment content.

16. The method of claim 15, wherein:
said commercial web site sells downloadable copies of the performed entertainment content or prerecorded media containing the performed entertainment content.

17. The method of claim 1, wherein:
said performing the entertainment content comprises playing a song using an audio system at the venue.

18. The method of claim 1, wherein:
said performing the entertainment content further comprises playing a video using a video display system at the venue.

19. The method of claim 1, further comprising:
transmitting to a host system identification information regarding the requested entertainment content.

20. The method of claim 19, further comprising:
based on the identification information regarding the requested entertainment content, retrieving additional information regarding the requested entertainment content.

21. The method of claim 20, wherein:
the additional information regarding the requested entertainment content comprises one or more of the following: a title of the requested entertainment content, an artist who recorded the requested entertainment content, or an album corresponding to the requested entertainment content.

22. An entertainment network, comprising:
an entertainment device for performing entertainment content in a venue in response to user requests;
a wireless link for providing network connectivity to one or more user devices in the venue; and
a host system comprising a web server, said host system being coupled to the entertainment device and the wireless link for providing information regarding entertainment content performed by the entertainment device to the one or more user devices in the venue via the wireless link.

23. The entertainment network of claim 22, wherein:
the wireless link comprises a wireless local area network (WLAN).

24. The entertainment network of claim 22, wherein:
said web server provides information regarding an entertainment content item currently being performed by the entertainment device.

25. The entertainment network of claim 22, wherein:
said web server provides information regarding entertainment content items previously performed by the entertainment device.

26. The entertainment network of claim 22, wherein:
said entertainment content comprises a song or video and said web server provides information regarding a title of the song or video and an artist who recorded the song or video.

27. The entertainment network of claim 22, wherein:
said web server requires a user to log into an access account to access a wide area network via the wireless link.

28. The entertainment network of claim 22, wherein:
said web server is configured to receive a request to perform entertainment content from a user device via the wireless link.

29. The entertainment network of claim 22, wherein:
said web server is configured to receive from a user device at the venue feedback regarding performed entertainment content.

30. The entertainment network of claim 29, wherein:
said web server is configured to receive from a user device feedback comprising a rating of the performed entertainment content.

31. The entertainment network of claim 22, wherein:
said web server is configured to generate data to be stored on a user device indicating the venue in which the user device is located.

32. The entertainment network of claim 30, wherein:
said data comprises a browser cookie.

33. The entertainment network of claim 22, wherein:
said web server is configured to provide a mechanism to enable a user to store on a user device a link to a web site including information regarding the performed entertainment content.

34. The entertainment network of claim 22, wherein:
said web server provides a web page including a link to a commercial web site offering sales of products related to the performed entertainment content.

35. The entertainment network of claim 34, wherein:
said commercial web site sells downloadable copies of the performed entertainment content or prerecorded media containing the performed entertainment content.

36. The entertainment network of claim 22, wherein:
said entertainment device is configured to perform the entertainment content by playing a song using an audio system at the venue.

37. The entertainment network of claim 22, wherein:
said entertainment device is configured to perform the entertainment content by playing a video using a video display system at the venue.

38. The entertainment network of claim 22, wherein:
said entertainment device is configured to transmit to the host system information regarding the requested entertainment content.

39. The entertainment network of claim 38, wherein:
said host system is configured to retrieve the additional information regarding the requested entertainment content based on the information regarding the requested entertainment content received from the entertainment device.

40. The entertainment network of claim 39, wherein:
said additional information regarding the requested entertainment content comprises one or more of the following: a title of the requested entertainment content, an artist who recorded the requested entertainment content, or an album corresponding to the requested entertainment content.

41. A method of operating an entertainment network, comprising:
receiving login information from a user device;
identifying a venue where the user device is located; and
providing information to the user device regarding entertainment content performed by an entertainment device at the venue.

42. The method of claim 41, wherein:
said providing information to the user device regarding entertainment content comprises providing information regarding an entertainment content item currently being performed by the entertainment device.

43. The method of claim 41, wherein:
said providing information to the user device regarding entertainment content comprises providing information regarding entertainment content items previously performed by the entertainment device.

44. The method of claim 41, wherein:
said entertainment content comprises a song and said providing information to the user device regarding entertainment content comprises providing information regarding a title of the song and an artist who recorded the song.

45. The method of claim 41, wherein:
said providing information to the user device comprises providing information regarding the performed entertainment content via a wireless link.

46. The method of claim 45, wherein:
said wireless link comprises a wireless local area network (WLAN).

47. The method of claim 45, further comprising:
requiring a user to log into an access account to access a wide area network via the wireless link.

48. The method of claim 41, further comprising:
receiving a request to perform entertainment content from the user device.

49. The method of claim 41, further comprising:
receiving from the user device at the venue feedback regarding performed entertainment content.

50. The method of claim 49, wherein:
said receiving from the user device feedback regarding the performed entertainment content comprises receiving from the user device a rating of the performed entertainment content.

51. The method of claim 41, wherein:
wherein said providing information to the user device comprises transmitting a web page to the user device at the venue, said web page including information regarding the performed entertainment content.

52. The method of claim 51, further comprising:
causing a user device to store data indicating the venue in which the user device is located.

53. The method of claim 52, wherein:
said data is stored by the user device as a browser cookie.

54. The method of claim 51, further comprising:
storing on a user device a link to a web site including information regarding the performed entertainment content.

55. The method of claim 41, further comprising:
providing a link to a commercial web site offering sales of products related to the performed entertainment content.

56. The method of claim 55, wherein:
said commercial web site sells downloadable copies of the performed entertainment content or prerecorded media containing the performed entertainment content.

57. The method of claim 41, wherein:
said entertainment content comprises a song performed using an audio system at the venue.

58. The method of claim 41, wherein:
said entertainment content comprises a video performed using a video display system at the venue.

59. The method of claim 41, further comprising:
receiving from the entertainment device identification information regarding entertainment content performed by the entertainment device at the venue.

60. The method of claim 59, further comprising:
based on the identification information regarding the performed entertainment content, retrieving additional information regarding the performed entertainment content.

61. The method of claim 60, wherein:
the additional information regarding the performed entertainment content comprises one or more of the following: a title of the performed entertainment content, an artist who recorded the performed entertainment content, or an album corresponding to the performed entertainment content.
